(19) United States
(12) Patent Application Publication
(10) Pub. No.: US 2026/0269089 A1
(43) Pub. Date: Sep. 10, 2026

(54) Fusion Capacitor

(71) Applicant: John Kissane, Far Hills, NJ (US)

(72) Inventor: John Kissane, Far Hills, NJ (US)

(21) Appl. No.: 19/063,392

(22) Filed: Mar. 4, 2025

(51) Int. Cl. G21B 3/00; G21G 1/12

(52) U.S. Cl. CPC G21B 3/00; G21G 1/12

(57) ABSTRACT

My invention exposes a blue flame to a capacitor while hitting it with a laser. The capacitor strips the atoms in the flame of their electrons exposing their nuclei to fuse and the laser provides the temperature increase needed for fusion. This is done on a large scale.

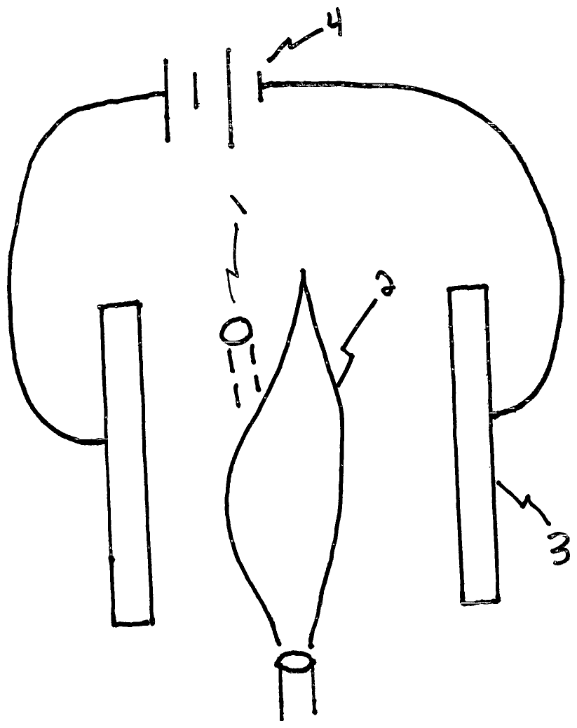

### BACKGROUND OF THE INVENTION

We know from the tokamak reactor that fusion can be done without the catastrophic effects of a bomb. This is known. Furthermore we know that a blue flame is already at a temperature that is half that needed for fusion. 2500-3000 degrees celsius. While the temperature of the sun where fusion takes place is 5507 degrees. If we could create conditions where the atoms are further enhanced by a capacitor and a laser, we could have a working reactor.

### BRIEF SUMMARY OF THE INVENTION

The invention shows how we could take the hottest blue flame, place it in between the plates of the strongest capacitor ever made and hit it with the strongest laser to produce nuclear fusion

### BRIEF DESCRIPTION OF THE DRAWING

The drawing shows a blue flame placed in between two plates of a capacitor being hit by a laser.

### DETAILED DESCRIPTION OF THE INVENTION

With the temperature of the blue flame already halfway needed to produce fusion the additional temperature boost provided by the laser would bring it closer to fusion. Furthermore the high powered capacitor would provide an electric field that would work to strip the electrons from the atoms in the flame thereby freeing up the nuclei to fuse. The beauty of this system is that if you want the reaction to stop all you need to do is cut the power to the laser, or the capacitor, or the flame, or all three. Of course this would all be contained in a reinforced concrete building for safety. The tokamak reactor proved that fusion could be done without a catastrophic explosion. They have been working with the tokamak for 50 years with no problem. They always complain in the physics community that they can get the reaction going but have no way of stopping it. My invention offers a way. Furthermore you are dealing with a flame, a plasma not a solid piece of metal like the core of a fusion bomb there is nothing to explode.

What I claim as my invention is:

1. A method of producing fusion for any practical purpose, this method uses a blue flame and exposes that flame to a capacitor and a laser to fuse the sparce atoms in that blue flame, because it does not have the density like the core of a nuclear fusion weapon it would not have the explosive power, furthermore there is a method of turning on and off the apparatus.
